(19) United States
(12) Patent Application Publication
(10) Pub. No.: US 2006/0064733 A1
(43) Pub. Date: Mar. 23, 2006

(54) Playing an audiovisual work with dynamic choosing

(76) Inventors: Jeffrey R. Norton, Venice, CA (US); Michelle M. Crames, Los Angeles, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/231,431

(22) Filed: Sep. 20, 2005

Related U.S. Application Data
(60) Provisional application No. 60/611,838, filed on Sep. 20, 2004.

(51) Int. Cl. H04N 7/16; H04N 7/10; H04N 7/025

(52) U.S. Cl. 725/135; 725/136; 725/32

(57) ABSTRACT

A method of playing an audiovisual work supports dynamic user choosing of story branches and outcomes. For example, a first segment of a digital audiovisual work is played. Upon reaching a decision point associated with the first segment, one or more decision selection icons are displayed in association with the first segment. The icons correspond to different branches in a story represented by the digital audiovisual work. User input representing a selection of one of the icons is received. One of a plurality of other segments of the digital audiovisual work is played, based on the user input. If no user input is received during a decision time period prior to an end of the first segment, automatically selecting one of the other segments and displaying the selected other segment. While awaiting the user input, the audiovisual work may continue to play so that the user viewing experience is uninterrupted.

### PRIORITY CLAIM

This application claims domestic priority under 35 U.S.C. §119(e) from prior provisional application 60/611,838, filed Sep. 20, 2004, the entire contents of which are hereby incorporated by reference as if fully set forth herein.

### FIELD OF INVENTION

The present invention generally relates to playing audiovisual works such as movies, stories, and other programs of entertainment, education or information. The invention relates more specifically to techniques for playing an audiovisual work based on interactive user selection of branches in a story embodied in the audiovisual work.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Audiovisual works such as movies, stories and other programs of entertainment, education or information are currently delivered through a variety of media including theatrical exhibition, television, videocassette, and digital versatile disc (DVD). Most such media provide little opportunity for user interaction in a story that is embodied in the media. For example, the involvement of a viewer in a program delivered through theatrical exhibition, television, and videocassette programs typically is entirely passive. The viewer simply views the program.

Certain forms of interactive broadcast television have been attempted on a trial basis in limited markets. Cable and satellite television services offer on-demand ordering of movies. However, these services ultimately result in delivering a story that unfolds in the same manner, from beginning to end, for each viewer.

Further, these media deliver a story in a single serial stream. The viewer sees the program starting at the beginning and ending at the end. Even though videocassette recorders and digital video recorders enable a viewer to stop, pause, fast-forward, rewind and skip to different defined scenes in a story, these media still deliver the story only in a serial manner that inevitably ends in the same way.

Programs delivered on DVD have offered a limited form of interactivity. For example, the title “Dungeons & Dragons: Scourge of Worlds” plays program information, but at story decision points, the program information fades to black and stops playing, and the viewer is prompted to answer a question. As a result, the viewer experience is frequently interrupted, which is undesirable. Such interruption conflicts with generally accepted principles of narrative storytelling because the storytelling is interrupted to ask the viewer to make a choice.

Examples of interactive DVD programs include: Multipath Movie and Multipath Adventure titles, produced on DVD by Brilliant Digital entertainment; Point of View, from DVD International and Digital Circus. In the computer game field, Multipath Adventure computer games delivered on CD-ROM are known. Examples include “Multipath Xena” and “Ace Ventura Pet Detective Multipath CD.”

In online content delivery, certain “Webisodes” are known, implemented using CGI scripts, under the title “Choose Your Own Nightmare.” Such webisodes have a number of drawbacks: they use computer graphics for display of characters and scenes in a manner that is not suitable for compelling storytelling; they require streaming content delivery, which interrupts the viewing experience; they require the viewer to own a complete computer system with high-speed network connectivity; and they do not permit the viewer to jump among branches of a story narrative.

Non-narrative DVD-based game products include “Scene-It,” distributed by Mattel, and “Trivial Pursuit.” Several DVD movies include games on the DVD, such as “Lion King One and a Half.”

Therefore, viewers and consumers of audiovisual works need a greater opportunity to interact with a story.

### BRIEF DESCRIPTION OF DRAWINGS

FIG. 1 is a block diagram showing a system for playing audiovisual works that may be used to implement an embodiment.

FIG. 2A is a block diagram showing a representation of a story that is organized as a tree.

FIG. 2B is a block diagram showing another hierarchical representation of a story that is organized as a tree.

FIG. 3A is a flow diagram showing a method of playing an audiovisual work.

FIG. 3B is a flow diagram of further steps in the method of FIG. 3A.

FIG. 4A is a block diagram showing a screen display of an audiovisual work.

FIG. 4B is a block diagram of another example of a screen display of an audiovisual work.

FIG. 4C is a block diagram showing an example system that may be used to author a digital versatile disc that embodies the techniques herein.

FIG. 4D is a screen display diagram showing an example graphical representation of a story tree.

FIG. 5 is a block diagram that illustrates a computer system 500 upon which an embodiment of the invention may be implemented.

### DETAILED DESCRIPTION

Playing an audiovisual work with dynamic choosing is now described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

1. General Overview

According to one aspect, a method of playing an audiovisual work supports dynamic user choosing of story branches and outcomes. For example, a first segment of a digital audiovisual work is played. Upon reaching a decision point associated with the first segment, one or more decision selection icons are displayed in association with the first segment. The icons correspond to different branches in a story represented by the digital audiovisual work. User input representing a selection of one of the icons is received. One of a plurality of other segments of the digital audiovisual work is played, based on the user input. If no user input is received during a decision time period prior to an end of the first segment, automatically selecting one of the other segments and displaying the selected other segment.

While awaiting the user input, the audiovisual work may continue to play so that the user viewing experience is uninterrupted.

According to one feature, the method further comprises receiving the user input representing selection of one of the icons before ending play of the first segment, and in response thereto: continuing to play the first segment; storing information associated with a next segment associated with the first segment and the selected icon; and when an end of the first segment is reached, playing the next segment based on the stored information.

In another feature, the story is organized according to a hierarchy of story branches associated with a plurality of segments, and the method further involves, in response to second user input, displaying the hierarchy of the story; receiving third user input, based on the displayed hierarchy, that requests movement to another point in the story; selecting a second segment of the digital audiovisual work based on the third user input; and playing the second segment.

In still another feature, automatically selecting comprises randomly automatically selecting one of the other segments. In another feature, each of the audiovisual segments is an audio track describing two or more different branches in a story. In yet another feature, each of the audiovisual segments is a split screen depicting two or more different branches in a story. In a further feature, an amount of decision time remaining is displayed.

2. Example System for Playing Audiovisual Works with Dynamic Choosing

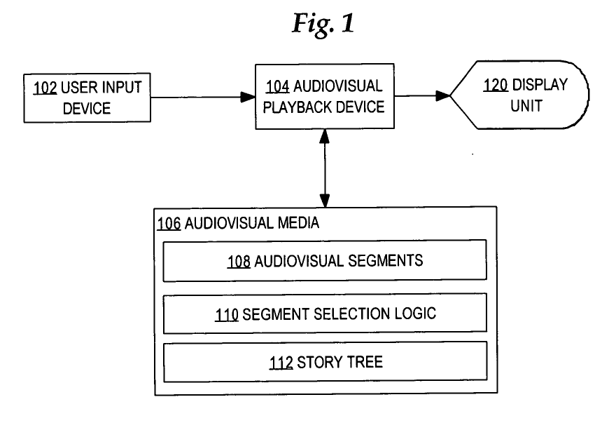

FIG. 1 is a block diagram showing a system for playing audiovisual works that may be used to implement an embodiment. A user input device 102 is communicatively coupled to an audiovisual (“AV”) playback device 104, which delivers audiovisual output to an audiovisual display unit 120. In one embodiment, AV playback device 104 is a digital versatile disc (DVD) player, user input device 102 is a remote control for the DVD player, and AV display unit 120 is a monitor or television. Any commercially available DVD recorder-player, or DVD player, such as model DVP-S560D from Sony Corporation, may be used for AV playback device 104.

An AV media 106 is communicatively coupled to AV playback device 104. AV media 106 comprises two or more AV segments 108, segment selection logic 110, and a story tree 112. AV segments 108 comprise recorded digitally playable audiovisual program information. For example, AV segments 108 comprise digital video portions corresponding to different narrative branches of a story. In this context, “story” means any form of audiovisual program, including but not limited to a movie, educational program, animated feature, instructional program, etc.

Typically AV media 106 is a random-access media such that the AV playback device 104 can retrieve and play back any of a plurality of segments or tracks of an AV work at any particular time. For example, AV media 106 may be a DVD, an audiovisual file stored on a random-access mass storage device of a computer or workstation, such as an MPEG file, or any other random-access media.

Segment selection logic 110 comprises recorded computer program instructions or other software elements that implement the techniques described further herein. In an embodiment, when AV media 108 is coupled to AV playback device 104, the AV playback device automatically reads the AV media, loads the segment selection logic 110, and executes instructions forming the segment selection logic 110. As a result, an AV program is presented according to the techniques herein. For example, in one embodiment, AV media 108 comprises a DVD that is playable by AV playback device 104.

Embodiments of the techniques herein may be used with other AV playback and display systems. Embodiments may be used with any suitable AV image formats including NTSC 525-line video, PAL, SECAM, or high-definition formats.

Further, embodiments are not limited to the use of DVD players and DVD media. For example, the techniques herein may be implemented for audiovisual works that are delivered using video-on-demand services that are delivered as part of satellite or cable television services, or delivered using broadband networks using any form of last-mile delivery such as cable, DSL, ADSL, satellite, ISDN, T1 or fractional T1, etc. Further, AV playback device 104 may be a digital video recorder (DVR), and AV media 108 may comprise a program recorded or loaded into the DVR. Any other suitable media now known or invented hereafter may be used to implement the general techniques described herein.

3. Hierarchiacal Story Representations

Story tree 112 is a stored data representation of branches and segments of a story and relationships among the segments, including decision points at which other segments may be selected through user input or automatic techniques, and segments associated with the decision points. For example, story tree 112 comprises information uniquely identifying each of the AV segments 108, including location on the AV media 106, duration, location of decision points, other segments associated with the decision points, etc.

In this description, the term “branch” refers to a portion of a story or narrative that leads to a particular conclusion, and the term “segment” refers to the audiovisual embodiment of a branch in stored form, such as a track on a DVD. The story tree may be a binary tree, a multi-way tree, or any other hierarchical representation of a story, segments, and relationships.

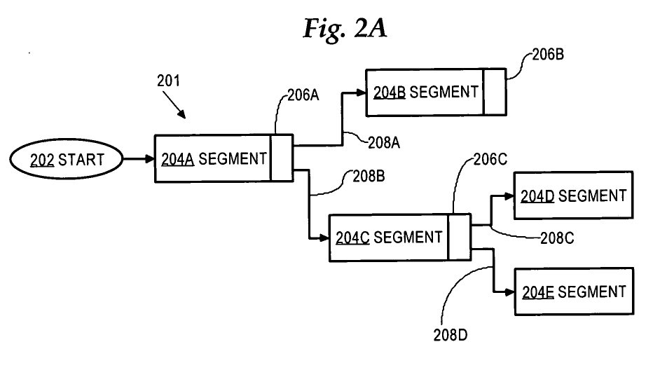

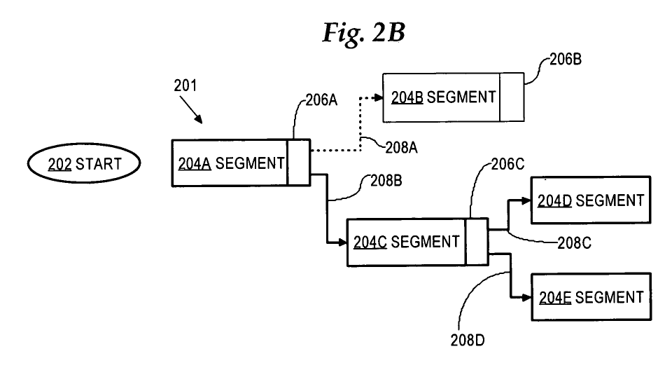

FIG. 2A is a block diagram showing a representation of a story that is organized as a tree. A story tree 201 for a complete story embodied in an audiovisual work may comprise a start point 202 and story segments 204A, 204B, 204C, 204D, 204E. For illustrating a clear example, FIG. 2A shows five (5) story segments 204A-204E. However, in other embodiments, any number of story segments may be used.

Each story segment 204A-204E comprises information describing a portion of the AV media 108. For example, in one embodiment, story segments 204A-204E comprise metadata specifying names and locations of program tracks on a DVD. The story segments 204A-204E represent discrete units of the AV program represented on the AV media 108. For example, story segments 204A-204E may comprise scenes, sets of scenes, chapters, or other narrative units.

Each story segment 204A-204E may comprise or be associated with a decision point. For example, in FIG. 2A the story segments 204A-204C are respectively associated with decision points 206A, 206B, 206C. In one embodiment, not all story segments have decision points. A decision point is associated with two or more branches in the story, and each branch is associated with another story segment. For example, decision point 206A is associated with branches 208A, 208B, and the branches are respectively associated with segments 204B, 204C.

FIG. 2B is a block diagram showing another hierarchical representation of a story that is organized as a tree. A first segment 232, “Intro” comprises a decision point at which the viewer may choose to branch to segment 234, “Ice fields,” or segment 242, “Valley.” Segment 234 branches to segment 236, “S.O.S.,” or segment 238, “Follow tracks.” Segment 242 branches to segment 244, “Take picture,” or segment 246, “Distract.” Segment 232 is associated with a first chapter of the story, either segment 234 or segment 242 comprises the second chapter, and either segments 236, 238, 244, 246 comprise the third chapter. In this arrangement, the story has up to four (4) distinct endings or outcomes that depend on multiple dynamic choices by the viewer.

4. Playing an Audiovisual Work with Dynamic Choosing

Techniques providing viewer interaction with a story that is presented in AV form are facilitated using AV media 108 that is organized according to a story tree such as that of FIG. 2A. For example, in one embodiment, a viewer may play a first segment of the AV work, and upon reaching a decision point, the viewer may provide input that determines which of a plurality of subsequent segments are played. If the viewer fails to provide such input within a specified period of time, such as before the end of the first segment, then software logic automatically selects a subsequent segment and plays the selected segment. At all times during the decision-making process, the first segment plays continuously without interrupting the user viewing experience.

The techniques described herein facilitate dynamic choosing of plot lines and other story elements in an audiovisual work. Dynamic choosing, as applied to an interactive DVD movie, enables the viewer of the movie to make a choice about the direction of the plot, in real time, which causes the movie to continue to play on the chosen plot path without disruption of the narrative flow of the story. As a result, an audiovisual work can embody a narrative story with multiple paths and multiple endings.

Further, in one embodiment, the viewer may display a hierarchical representation of the story and may re-visit previous decision points.

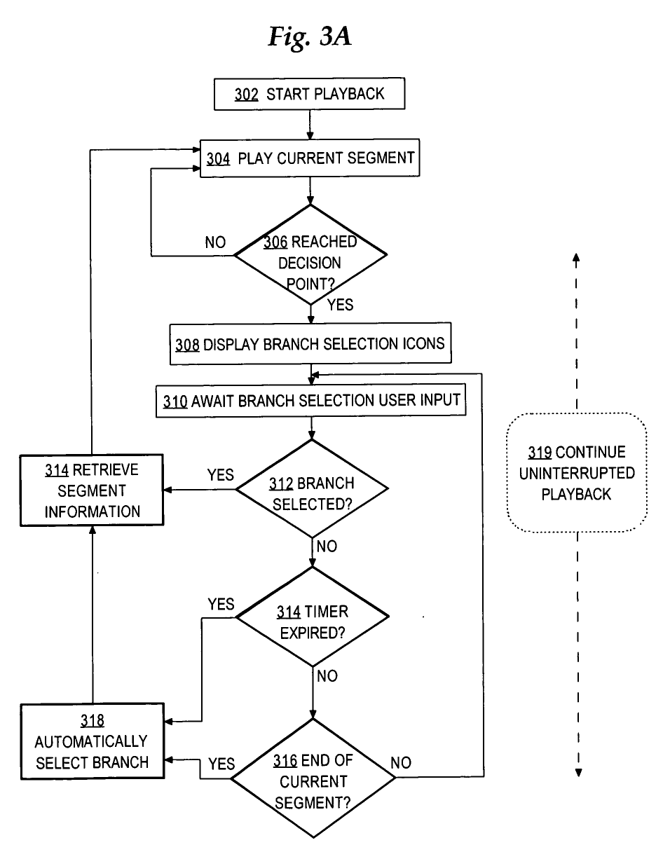

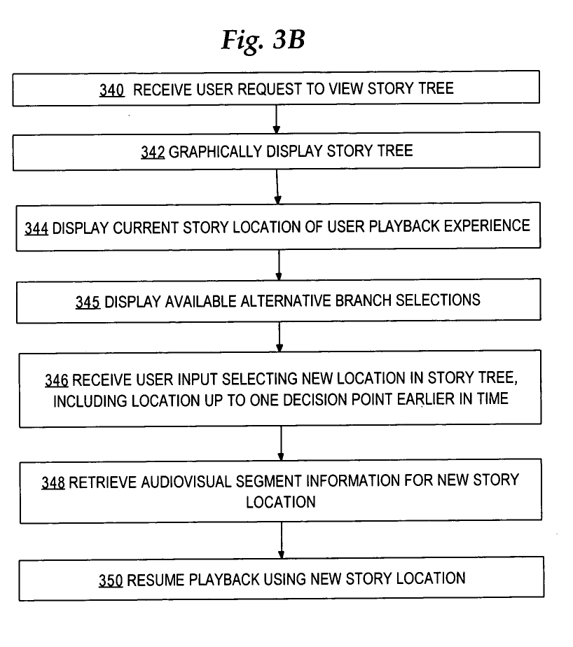

FIG. 3A is a flow diagram showing a method of playing an audiovisual work, and FIG. 3B is a flow diagram of further steps in the method of FIG. 3A. For purposes of describing a clear example, FIG. 3A and FIG. 3B are described herein in the context of the system of FIG. 1 and the story representations of FIG. 2A, FIG. 2B. However, in other embodiments, the general techniques of FIG. 3A, FIG. 3B may be implemented using other systems and other story representations.

At step 302, playback of an audiovisual work begins. In an embodiment, step 302 also includes loading segment selection logic 110 into audiovisual playback device 104 and executing the logic in the playback device. At step 304, a current segment of the audiovisual work is played. For example, audiovisual playback device 106 plays a first of the audiovisual segments 108 on audiovisual media 106, such as a track of a DVD.

At step 306, a test is performed to determine if a decision point has been reached. For example, segment selection logic 110 continuously monitors the playback of segments of a story and determines whether decision points associated with the segments have been reached. As indicated by the NO branch arrow from step 306, a segment is played continuously until a decision point is reached.

When a decision point is reached, then one or more branch selection icons are displayed, as shown in step 308. In one embodiment, branch selection icons are displayed in super-imposition over the video content of a particular segment as the segment is played. In one example embodiment, the branch selection icons are implemented as stored TIFF format graphical images and are displayed in a subtitle area of the video screen of AV display unit 102. One, two, three, or more branch selection icons may be displayed.

In one embodiment, characters that are displayed as part of the AV work may visually and audibly explain story branch selections that are associated with the branch selection icons. Thus, each choice may be verbally explained by a character on the screen. However, such explanation is not required, in an embodiment.

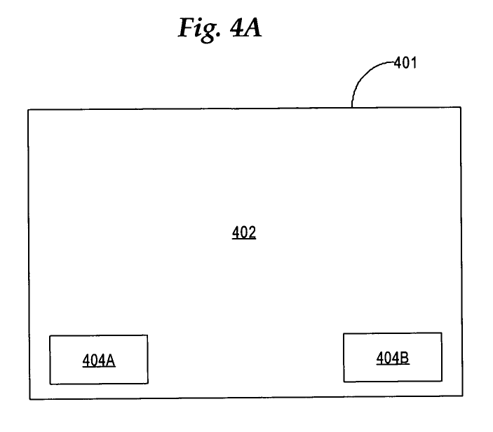

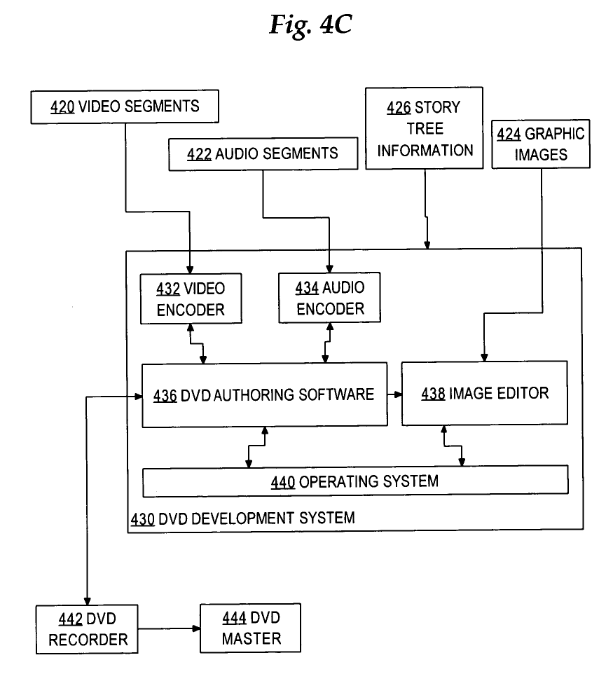

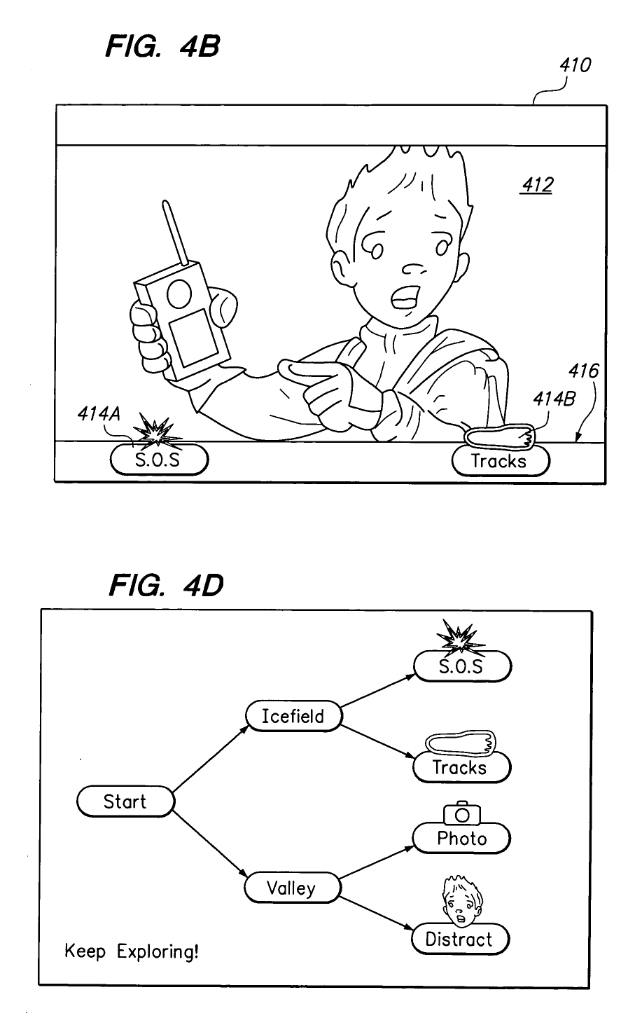

As an example, FIG. 4A is a block diagram showing a screen display of an audiovisual work. A screen display 401 comprises a program frame 402 and selection icons 404A, 404B. Program frame 402 shows the audiovisual work as it is played by the AV playback device. Selection icons 404A, 404B are superimposed over the frame 402, and comprise graphical symbols, words, or other representations of story branches.

FIG. 4B is a block diagram of another example of a screen display of an audiovisual work. In the example of FIG. 4B, a screen display 410 comprises a program frame 412 and selection icons 414A, 414B in subtitle region 416. Program frame 412 shows an animated audiovisual work as it is played by the AV playback device. Selection icons 414A, 414B comprise graphical pictures and words that convey the nature of story branches associated with the icons.

Referring again to FIG. 3A, at step 310, branch selection user input is awaited. For example, in one embodiment, segment selection logic 110 senses whether a viewer has selected one of the branch selection icons using user input device 102. However, as indicated by block 319, playback of the current segment continues uninterrupted while the user input is awaited. Using this approach, the user viewing experience is not disrupted. As indicated generally by the logic of steps 312, 314, 316, such continuous playback continues until the viewer selects a story branch by selecting one of the branch selection icons, or until a specified time elapses, or until the current segment ends.

In step 312, a test is performed to determine if user input selecting a branch has been received. Selection of a branch selection icon may comprise, for example, a viewer using a DVD remote to operate left and right arrow buttons to navigate a cursor among the branch selection icons and “hover” the cursor over the icons, or pressing a Select button to indicate a selection of an icon.

In one embodiment, if a user has indicated a selection by hovering the cursor over a selection icon at step 312 before the end of the current segment, and has not pressed a Select button on the DVD remote, then the selection is stored or “locked in,” but the selected next story branch or segment is not immediately played. Instead, the current segment continues to play until its end is reached, and at that point, the next segment is retrieved and played. However, if the Select button is pressed, then the selected next story branch or segment is immediately played. In this approach, a viewer may dynamically choose story branches or plot twists without interruption of playback and, therefore, without interruption of the narrative flow of the story, unless the viewer expressly indicates a desire to interrupt the story and move on by pressing the Select button.

In one embodiment, immediately after user input selecting a branch is received at step 312, in step 314, information relating to the selected segment is retrieved. For example, segment selection logic 110 retrieves, from story tree 112 or other suitable stored data, information indicating the location in AV media 106 of a segment or track associated with the next selected segment. When playback of the current segment ends, then control passes to step 304 in which the selected segment is played until the next decision point or the end of that segment. In a DVD implementation, the DVD player locates the track that corresponds to the story branch of the selected icon, and starts playing that track. To the viewer, the story narrative pauses only for so long as the DVD requires to leave the current track and begin playing the next track, or about 1-2 seconds for conventional DVD players.

Alternatively, step 314 also can be performed when the current segment stops playing.

Using either alternative, a viewer selection of a story branch can be “locked in” without interrupting playback of the current story segment. When the end of the story segment is reached, playback continues, without interruption, at the story branch that has been selected by the viewer. As a result, a smooth and uninterrupted AV playback experience is provided with dynamic choosing.

If no branch is selected at step 312, then in step 314, a test is performed to determine if a timer has expired or a specified time has elapsed. For example, in one embodiment, segment selection logic 110 may be configured to give a viewer a specified period of time in which to select a segment. Thus, segment selection logic. 110 might allow a viewer a period of about 15 seconds in which to make a selection, and the time period may be configured to end shortly before the end of the current segment. If the timer expires, then in step 318 a story branch or next segment is automatically selected.

In one embodiment, the amount of time remaining to make a selection of a story branch icon may be indicated graphically in the display screen. For example, a graphical image of a clock, hourglass, or other prompt may be displayed in program frame 402 or near selection icons 404A, 404B.

Using this approach, a viewer is allowed a period of time to select a branch and if no selection occurs then the system selects a story branch or next segment automatically. If the timer expires before the current segment ends, then the system may automatically select the next segment and start playing it immediately after the current segment ends, so that the viewer experience is smooth and uninterrupted. Further, automatic selection of story branches facilitates delivery of stories and programs to younger viewers who are not capable of operating a DVD remote or other user input device 102. For these viewers, the story plays continuously as story branches are automatically selected when decision points are reached.

In an embodiment, the timer approach of step 314 may be omitted.

In step 316, a test is performed to determine if the end of the current segment has been reached. If so, then in step 318 a next story branch or segment is automatically selected for the viewer. In one embodiment, information identifying one or more next segments is associated with each segment in story tree 201 as part of the decision points 206A, 206B, 206C, etc., and segment selection logic 110 randomly selects one of the associated next segments. In another embodiment, a default next segment is indicated in the decision points 206A, 206B, 206C, and segment selection logic 110 selects the default next segment.

After selection of a next story branch or segment at step 318, control passes to step 314 in which segment information for the next story branch or segment is retrieved, as described above.

In various alternative embodiments, decision points or choices in a story may be identified or highlighted using means other than selection icons. In one embodiment, a screen within a screen highlights a particular interactive choice. For example, at a decision point a split screen may be displayed, comprising one half that visualizes a first choice and a second half that visualizes a second. Each half of the split screen may contain a video segment that plays concurrently with the other half, a static image, or other information. The viewer can highlight an entire half of the screen, which may then be viewed as a highlighted screen box, in the same way as interacting with the icons. Thus, the viewer could highlight or select a box within the screen that contains a moving image suggesting a plot choice.

In another embodiment, an object that is displayed in the current video segment may be a selectable element that indicates a plot choice or selection. Thus, an object in the screen may be defined as a “hot button” that can be selected through user input. For example, if a particular story narrative provided a choice to use a pick axe or a rope, these respective objects on the screen would be able to be highlighted and could be selected.

Referring now to FIG. 3B, a method of selecting alternative story branches is shown. The approach of FIG. 3B facilitates “branch jumping,” in which a viewer can jump from story branch to story branch based on selecting branches from a graphical story hierarchy display.

In step 340, a user request to view a story tree is received. For example, a viewer may select a “Menu” button of the user input device 102, or any other suitable function indicator. In response, in step 342, a graphical representation of a story tree is displayed. In one embodiment, for example, selecting a Menu button of the user input device 102 causes segment selection logic 110 to stop playback of any audiovisual segments 108 that are currently playing and to display a graphical representation of story tree 201 on the display unit 120. Additionally or alternatively, the graphical representation of the story tree may be presented automatically at the end of a particular branch or segment.

FIG. 4D is a screen display diagram showing an example graphical representation of a story tree. The particular form of the graphical representation is not critical, and may include names of story branches, decision icons, or any other information that is considered useful or visually appealing to a viewer. Typically the graphical representation may include graphics of information sufficient to assist the viewer in understanding the structure of the story and what branches the viewer can select.

In step 344, the current story location of the user playback experience is displayed. In one embodiment, step 344 involves highlighting, in the graphical representation displayed at step 344, the viewer's current location in the story.

In step 345, available alternative branch selections are displayed. In an embodiment, after viewing the AV work and making at least one branch selection at two one or more decision points, the user is permitted to “backtrack” in the story and resume playing the story at any segment that the viewer has previously seen, but the viewer cannot access any segment that follows a segment that the viewer has not yet viewed. Thus, in an embodiment, decision points and branches that the viewer cannot select are not shown, grayed-out, or otherwise indicated in the graphical representation of the story tree. For example, referring to FIG. 2B, assume that a viewer has viewed segment 204A, selected branch 208B at decision point 206A, and viewed segment 204C, but not yet reached decision point 206C. The viewer is allowed to stop playing segment 204C, display a graphical representation of story tree 201, and select and replay any of segments 204A, 204B, 204C, even though the viewer elected not to view segment 204B. However, the viewer is not permitted to view segments 204D, 204E, which are after a decision point that has not been reached. Therefore, segments 204D, 204E are not shown, grayed-out, or otherwise indicated as unavailable.

In step 346, user input selecting a new location in the story tree is received, including a location up to one decision point earlier in time. As described above for FIG. 2B, the viewer may select decision point 206C, but not decision point 206A. In one embodiment, a viewer uses arrow buttons or other movement selection buttons of user input device 102 to navigate the graphical representation of story tree 201 and select a new segment. When the decision point is selected, segment selection logic 110 retrieves information associated with the selected new segment, as shown by step 348. In step 350, AV playback device 104 resumes playing the selected segment.

FIG. 4C is a block diagram showing an example system that may be used to author a digital versatile disc that embodies the techniques herein.

One or more video segments 420, audio segments 422, and graphic images 424 are provided to a DVD development system 430. In one embodiment, DVD development system 430 comprises a personal computer, workstation, or similar device that hosts an operating system 440, DVD authoring software 436, image editor 438, video encoder 432, and audio encoder 434. In a practical embodiment, system 430 may include other elements of hardware or software in addition to those shown in FIG. 4C.

In an example implementation, operating system 440 may comprise Mac OS X from Apple Computer, Inc. DVD authoring software 436 may comprise Spruce, from Sonic, or Scenaris. Image editor 438 may comprise Adobe Photoshop. Video encoder 432 and audio encoder 434 are optional and are implemented when the digital format of video segments 420 and audio segments 422 are incompatible with DVD storage formats. For example, if video segments 420 are recorded in digital Betacam format, the video segments are provided to a video encoder 432, such as the Minerva C215 hardware MPEG encoder, to transform the bit-rate of the video segments into a format compatible with DVD storage. Similarly, audio segments 422 may be transformed using an AC3 encoder, for example.

Further, image editor 438 is also option and is used only when, for example, graphic images 424 require editing or transformation prior to use in the system as story branch selection icons.

DVD authoring software 436 is used to develop a DVD master 444, which may be recorded by sending digital output from the DVD authoring software to a DVD recorder 442, using the following general process. After transformation as necessary or appropriate, video segments 420, audio segments 422, and graphic images 424 are stored in a file directory on DVD development system 430. Functions of DVD authoring software 436 are used to assign audio segments and video segments to DVD tracks in a digital representation of the master DVD 444 that is displayed by the authoring software with its graphical user interface.

Decision points are defined in each track using built-in functions of the authoring software 436. At each decision point, sub-pictures are associated with the decision points, and filenames or other names of graphic images 424 are associated with the sub-pictures. The sub-pictures define highlighting or other effects that surround the icons that are displayed at the decision points. The authoring software 436 integrates the sub-pictures and the graphic images 424 into the video segments that are played at the decision points. As a result, playing the audiovisual work at a decision point cases the AV playback device 104 to show a video segment that includes the icons, with highlighting or other effects in response to selection of the icons using the user input device 102.

A duration value is defined for each of the decision actions and stored using the authoring software 436. For each track, an end action is defined. An end action defines what the AV playback device 104 should do when the end of a track is reached. An end action may embody a conditional decision based on user input such as selection of the story branch icons or particular values that are received using the DVD remote. Code or logic embodying a random selection of a next track may be associated with an end action. In this manner, the DVD authoring software 436 is used to program a stored digital representation of the master DVD 444 with logic specifying what to do when the end of a track is reached, and how to perform a random selection of a next track if no user input is received from the DVD remote upon reaching the end of the specified duration for the decision actions and end actions.

The definition of tracks, decision points, graphic images, duration values, end actions, etc., may be made based upon story tree information 426. Thus, in one embodiment, a complete story tree is determined in advance and then used as a guide to determine how to arrange decision points and tracks that correspond to the narrative flow of a story as represented in the story tree.

5. Implementation Mechanisms—Hardware Overview

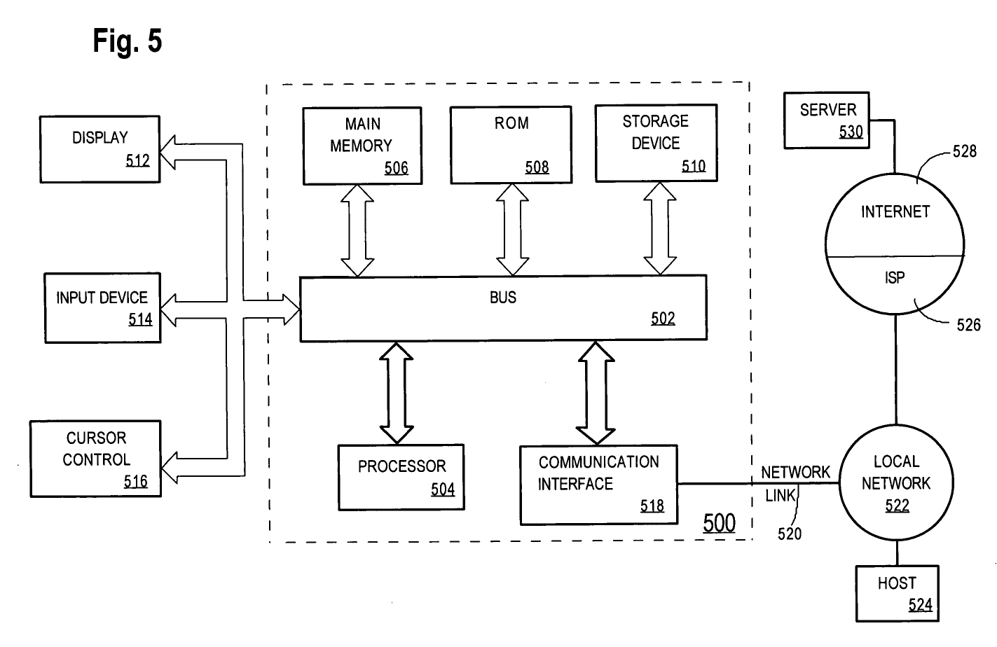

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (“RAM”) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (“ROM”) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (“CRT”), for displaying information to a computer user. An input device 514, including alphanumeric and other keys, is coupled to bus 502 for communicating information and command selections to processor 504. Another type of user input device is cursor control 516, such as a mouse, trackball, stylus, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for playing an audiovisual work with dynamic choosing. According to one embodiment of the invention, displaying an audiovisual work with dynamic choosing is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (“ISDN”) card or a modem to provide a data communication connection to a corresponding type of telephone line. As another example, communication interface 518 may be a local area network (“LAN”) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (“ISP”) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for displaying an audiovisual work with dynamic choosing as described herein.

The received code may be executed by processor 504 as it is received, and/or stored in storage device 510, or other non-volatile storage for later execution. In this manner, computer system 500 may obtain application code in the form of a carrier wave.

6. Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method, comprising:
playing a first segment of a digital audiovisual work;
upon reaching a decision point associated with the first segment, displaying one or more decision selection icons in association with the first segment, wherein the icons correspond to different branches in a story represented by the digital audiovisual work;
receiving user input representing a selection of one of the icons;
playing one of a plurality of other segments of the digital audiovisual work based on the user input;
if no user input is received during a decision time period prior to an end of the first segment, automatically selecting one of the other segments and displaying the selected other segment.

2. A method as recited in claim 1, further comprising:
receiving the user input representing selection of one of the icons before ending play of the first segment, and in response thereto:
continuing to play the first segment;
storing information associated with a next segment associated with the first segment and the selected icon;
when an end of the first segment is reached, playing the next segment based on the stored information.

3. A method as recited in claim 1, wherein the story is organized according to a hierarchy of story branches associated with a plurality of segments, and further comprising:
in response to second user input, displaying the hierarchy of the story;
receiving third user input, based on the displayed hierarchy, that requests movement to another point in the story;
selecting a second segment of the digital audiovisual work based on the third user input;
and
playing the second segment.

4. A method as recited in claim 1, wherein automatically selecting comprises randomly automatically selecting one of the other segments.

5. A method as recited in claim 1, wherein each of the audiovisual segments is an audio track describing two or more different branches in a story.

6. A method as recited in claim 1, wherein each of the audiovisual segments is a split screen depicting two or more different branches in a story.

7. A method as recited in claim 1, wherein an amount of decision time remaining is displayed.

8. An apparatus for playing an audiovisual work, the apparatus comprising:
means for playing a first segment of a digital audiovisual work;
means for playing one or more audiovisual elements in association with the first segment, wherein each of the elements corresponds to a different branch in a story represented by the digital audiovisual work, upon reaching a decision point associated with the first segment;
means for receiving user input representing a selection of one of the branches;
means for playing one of a plurality of other segments of the digital audiovisual work based on the user input; and
means for automatically selecting one of the other segments and playing selected other segment, if no user input is received during a decision time period prior to an end of the first segment.

9. An apparatus as recited in claim 8, further comprising:
means for receiving the user input representing selection of one of the icons before ending play of the first segment:
means for continuing to play the first segment;
means for storing information associated with a next segment associated with the first segment and the selected icon;
means for playing the next segment based on the stored information when an end of the first segment is reached.

10. An apparatus as recited in claim 8, wherein the story is organized according to a hierarchy of story branches associated with a plurality of segments, and further comprising:
means for displaying the hierarchy of the story in response to second user input;
means for receiving third user input, based on the displayed hierarchy, that requests movement to another point in the story;
means for selecting a second segment of the digital audiovisual work based on the third user input; and
means for playing the second segment.

11. An apparatus as recited in claim 8, wherein automatically selecting comprises randomly automatically selecting one of the other segments.

12. An apparatus as recited in claim 8, wherein each of the audiovisual segments is an audio track describing two or more different branches in a story.

13. An apparatus as recited in claim 8, wherein each of the audiovisual segments is a split screen depicting two or more different branches in a story.

14. An apparatus as recited in claim 8, wherein an amount of decision time remaining is displayed.

15. A machine-readable medium carrying one or more sequences of instructions which, when executed by one or more processors, causes the one or more processors to perform the following steps:
playing a first segment of a digital audiovisual work;
upon reaching a decision point associated with the first segment, displaying one or more decision selection icons in association with the first segment, wherein the icons correspond to one or more different branches in a story represented by the digital audiovisual work;
receiving user input representing a selection of one of the icons;
playing one of a plurality of other segments of the digital audiovisual work based on the user input; and
if no user input is received during a decision time period prior to an end of the first segment, automatically selecting one of the other segments and displaying the selected other segment.

16. A machine-readable medium as recited in claim 15, further comprising instructions for performing:
receiving the user input representing selection of one of the icons before ending play of the first segment, and in response thereto:
continuing to play the first segment;
storing information associated with a next segment associated with the first segment and the selected icon;
when an end of the first segment is reached, playing the next segment based on the stored information.

17. A machine-readable medium as recited in claim 15, wherein the story is organized according to a hierarchy of story branches associated with a plurality of segments, and further comprising instructions for performing:
in response to second user input, displaying the hierarchy of the story;
receiving third user input, based on the displayed hierarchy, that requests movement to another point in the story;
selecting a second segment of the digital audiovisual work based on the third user input; and
playing the second segment.

18. A machine-readable medium as recited in claim 15, wherein automatically selecting comprises randomly automatically selecting one of the other segments.

19. A machine-readable medium as recited in claim 15, wherein each of the audiovisual segments is an audio track describing two or more different branches in a story.

20. A machine-readable medium as recited in claim 15, wherein each of the audiovisual segments is a split screen depicting two or more different branches in a story.

21. A machine-readable medium as recited in claim 15, wherein an amount of decision time remaining is displayed.

22. A method, comprising:
sending one or more data streams associated with a first segment of a digital audiovisual work to an audiovisual output device;
determining that the output device has reached a decision point associated with the first segment;
sending one or more audiovisual elements associated with the first segment to the output device, wherein each of the elements corresponds to one or more different branches in a story represented by the digital audiovisual work;
receiving user input representing a selection of one of the branches;
selecting one of a plurality of other segments of the digital audiovisual work based on the user input;
sending one or more data streams associated with the selected segment to the output device; and
if no user input is received during a decision time period prior to the output device reaching an end of the first segment, automatically selecting one of the other segments and sending one or more data streams associated with the selected segment to the output device.

23. A method as recited in claim 22, further comprising:
receiving the user input representing selection of one of the branches before ending play of the first segment, and in response thereto:
continuing to play the first segment;
storing information associated with a next segment associated with the first segment and the selected icon;
when an end of the first segment is reached, playing the next segment based on the stored information.

23. A method as recited in claim 24, wherein the story is organized according to a hierarchy of story branches associated with a plurality of segments, and further comprising:
in response to second user input, displaying the hierarchy of the story as a graphical story tree;
graphically highlighting a current story location in the graphical story tree;
displaying one or more available alternative branch selections;
receiving third user input, based on the displayed hierarchy, that requests movement to another point in the story, including a location up to only one decision point earlier in time;
selecting a second segment of the digital audiovisual work based on the third user input; and
playing the second segment.

24. A method as recited in claim 22, wherein said one or more audiovisual elements is an audio track describing two or more different branches in a story.

25. A method as recited in claim 22, wherein said one or more audiovisual elements is a split screen depicting two or more different branches in a story.

26. A method as recited in claim 22, wherein sending one or more audiovisual elements associated with the first segment further comprises sending one or more audiovisual elements indicating an amount of decision time remaining.
